(19) United States
(12) Patent Application Publication
(10) Pub. No.: US 2010/0295696 A1
(43) Pub. Date: Nov. 25, 2010

(54) Digital Display Apparatus for Fastener Pulling Tool

(76) Inventors: Hsiu-Feng Chu, Chungli City (TW); Shan-Chien Peng, Chungli City (TW); Yi-Hung Lin, Chungli City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/783,630

(22) Filed: May 20, 2010

(30) Foreign Application Priority Data
May 22, 2009 (CN) 200910143272.6

(51) Int. Cl. G08B 21/00

(52) U.S. Cl. 340/686.1; 340/665; 173/20

(57) ABSTRACT

A digital display apparatus for a fastener pulling tool to set a fastener (e.g., rivet, blind rivet or blind threaded insert), driven by pneumatic, hydraulic or pneudraulic power, includes a power supply, a CPU, a pressure sensor, position sensors, a display, and an input means; wherein the pressure sensor is operable to sense pressure of hydraulic or pneumatic fluid entering the fastener pulling tool; the CPU includes a pressure and pulling force calculation module an unit conversion module, an over pressure determination module, a cycle times counting module, and an abnormal stroke detecting module; and the display includes a pressure display zone for showing hydraulic or pneumatic pressure and a pulling force display zone for showing pulling force, a non-resettable over pressure display zone showing the highest inlet pressure, and a cycle time display zone for showing non-resettable accumulated working cycles of the tool.

### BACKGROUND OF THE INVENTION

1. Field of Invention

The invention relates to pneumatic, hydraulic or pneudraulic (pneumatic and hydraulic) tools for pulling fasteners and more particularly to a digital display apparatus for a tool of pulling a fastener (e.g., rivet, blind rivet or blind threaded insert).

2. Description of Related Art

A type of typical tool for pulling a fastener (e.g., rivet, blind rivet or blind threaded insert) is driven by pneumatic, hydraulic or pneu-draulic power. However, no display of pressure of the working medium is available for an individual while operating the tool. It is understood that the tool driven by insufficient working pneumatic or hydraulic pressure cannot pull the fasteners successfully and need to be reworked for example, a blind rivet or blind threaded insert. Also, working pressure over designed specification may damage components especially oil seals of the tool and cause leaking. Unfortunately, the operator is not aware of the same since no display of such data, and warranty claim is often disputed as the cause for breakdown is unclear.

Another type of pneumatic fastener pulling tool has a simple counter equipped. However, it is always initialized prior to use. Thus, the accumulated cycle times of using the tool is not available for reminding operators to do maintenance or taking it for offering effective warranty by non-resettable cycle times. Furthermore, no warning means are provided for fastening tools alike, such as over pressure may abuse the oil seals and cause internal fluid leakage or insufficient pulling stroke resulting in failure setting and need to be reworked, etc. Thus, the need for improvement still exists.

### SUMMARY OF THE INVENTION

It is therefore one object of the invention to provide a digital display apparatus for a fastener pulling tool driven by pneumatic, hydraulic or pneudraulic power to set a fastener (e.g., rivet, blind rivet or blind threaded insert), comprising a power supply; a central processing unit (CPU); a pressure sensor; a plurality of position sensors; a display; and input means; wherein the power supply is operable to supply power to the digital display apparatus; the input means is electrically connected to the CPU; the pressure sensor is electrically connected to the CPU for communicating data therewith; the display is electrically connected to the CPU for showing information therefrom; the pressure sensor is operable to sense pressure of hydraulic or pneumatic fluid entering the fastener pulling tool; the CPU comprises a pressure and pulling force calculation module and a unit conversion module; and the display comprises a pressure display zone for showing hydraulic or pneumatic pressure and a pulling force display zone for showing pulling force corresponding to the tool inlet pressure instantly; and a non-resettable over pressure display zone always showing the maximum tool inlet pressure as soon as it exceeds the designed specification and a non-resettable cycle time display showing accumulated cycle times, the input means is operable for entering operation parameters in CPU for predetermined data and selecting the unit of pressure or pulling force shown on the display zone by operator himself.

The above and other objects, features and advantages of the invention will become apparent from the following detailed description taken with the accompanying drawings.

### BRIEF DESCRIPTION OF THE DRAWINGS

FIG. 1 is a perspective view of a fastener pulling tool and a digital display apparatus therefore according to the invention;

FIG. 2 is a front view of the digital display apparatus in FIG. 1;

FIG. 3A is a longitudinal sectional view of the tool in FIG. 1 showing the pressure sensor and the position sensor mounted in a pneudraulic fastener pulling tool according to the invention;

FIG. 3B schematically shows the operation of the hydraulic piston in FIG. 3A;

FIG. 3C schematically shows the operation of the pneumatic piston in FIG. 3A;

FIG. 4A is a longitudinal sectional view showing the pressure sensor and the position sensor mounted in a pneumatic fastener pulling tool according to the invention;

FIG. 4B schematically shows the operation of the pneumatic piston in FIG. 4A;

FIG. 5A is a longitudinal sectional view showing the pressure sensor and the position sensor mounted in a hydraulic fastener pulling tool according to the invention;

FIG. 5B schematically shows the operation of the hydraulic piston in FIG. 5A;

FIG. 6 is a block diagram of the digital display apparatus;

FIG. 7 is a flow chart illustrating sensing and logic calculating sequence of the invention;

FIG. 8 plots pressure versus pulling force for pneumatic, hydraulic and pneudraulic fastener pulling tools according to the invention;

FIG. 9A schematically shows the pulling force is built by applying the hydraulic pressure to the effective working area of the hydraulic piston of the pneudraulic fastener pulling tool according to the invention;

FIG. 9B schematically shows the hydraulic pressure is built by applying the pneumatic pressure to the pneumatic piston and piston rod of the pneudraulic fastener pulling tool according to the invention;

FIG. 9C schematically shows the pulling force is built by applying the pneumatic pressure to the effective working area of the pneumatic piston of the pneumatic fastener pulling tool according to the invention;

FIG. 9D schematically shows the pulling force is built by applying the hydraulic pressure to the effective working area of the hydraulic piston of the hydraulic fastener pulling tool according to the invention;

FIG. 10 is a circuit diagram of the digital display apparatus;

FIGS. 11A, 11B, 11C, 11D and 11E are fragmentary views of FIG. 3A showing normal operations of the position sensor;

FIGS. 12A, 12B, 12C, 12D and 12E are fragmentary views of FIG. 3A showing abnormal operations of the position sensor; and

FIGS. 13A, 13B, 13C, 13D and 13E are fragmentary views of FIG. 3A showing another abnormal operations of the position sensor.

### DETAILED DESCRIPTION OF THE INVENTION

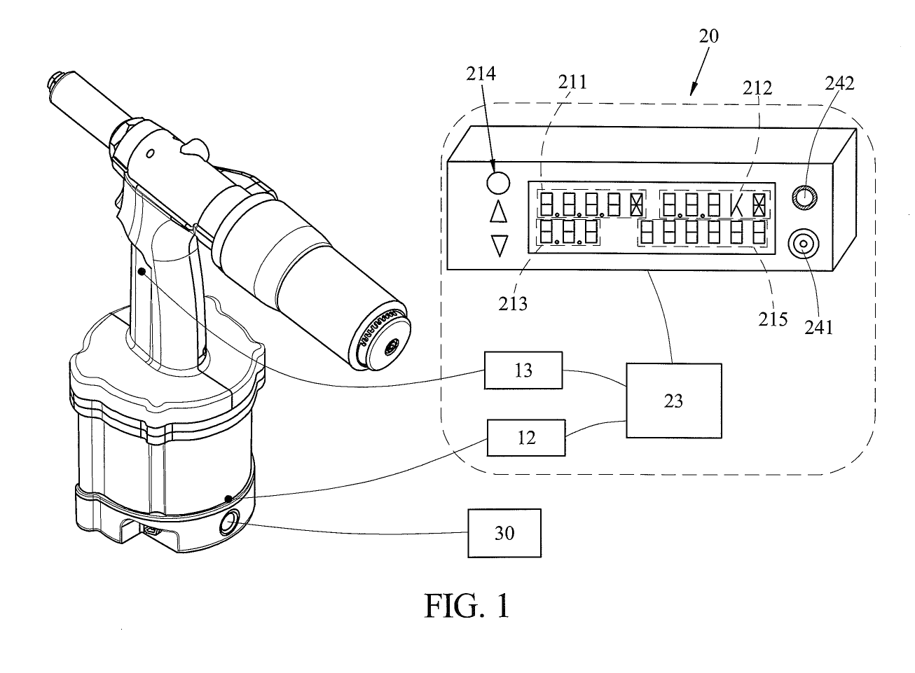

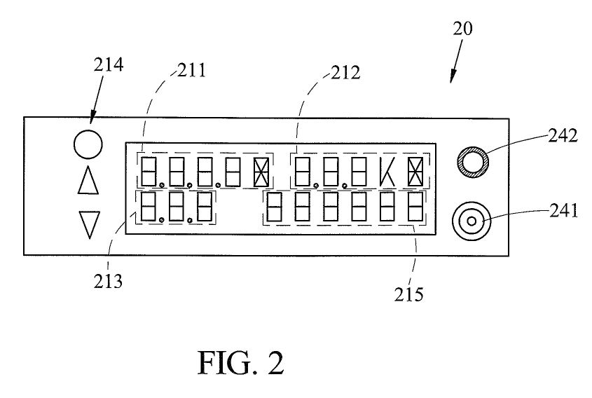

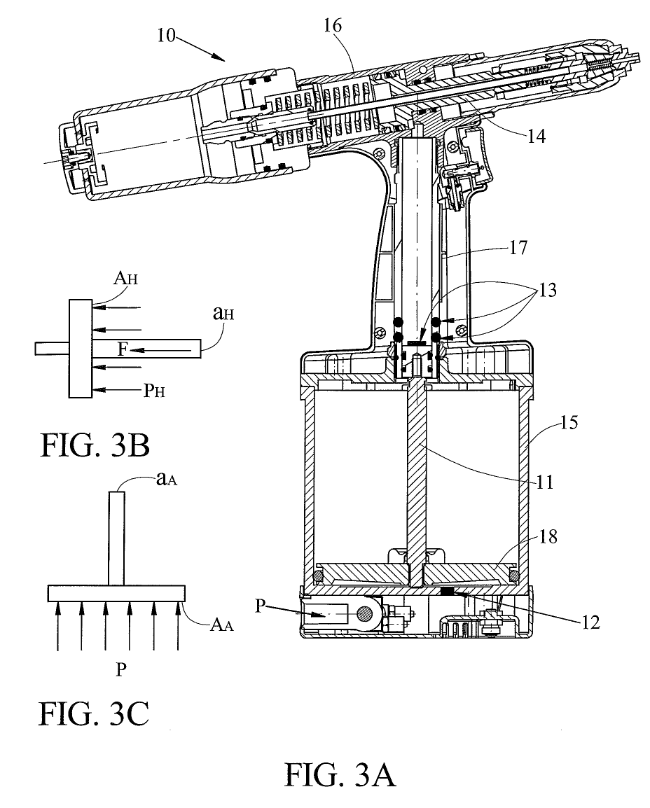

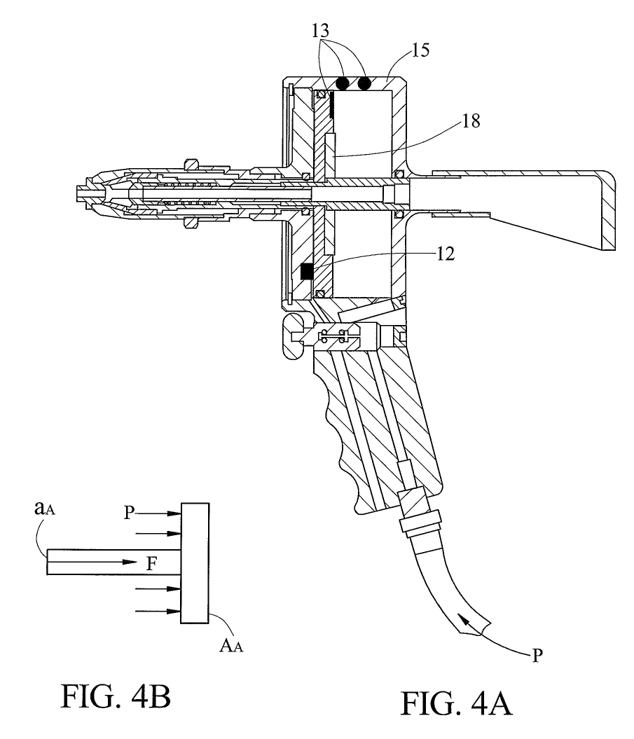

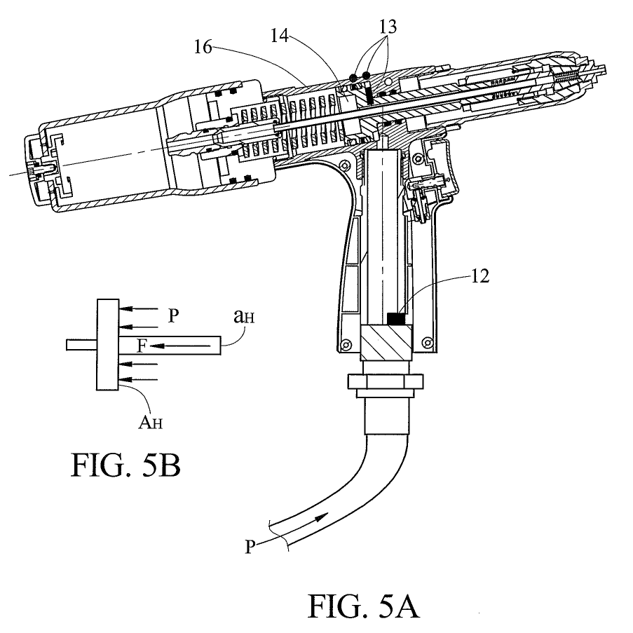

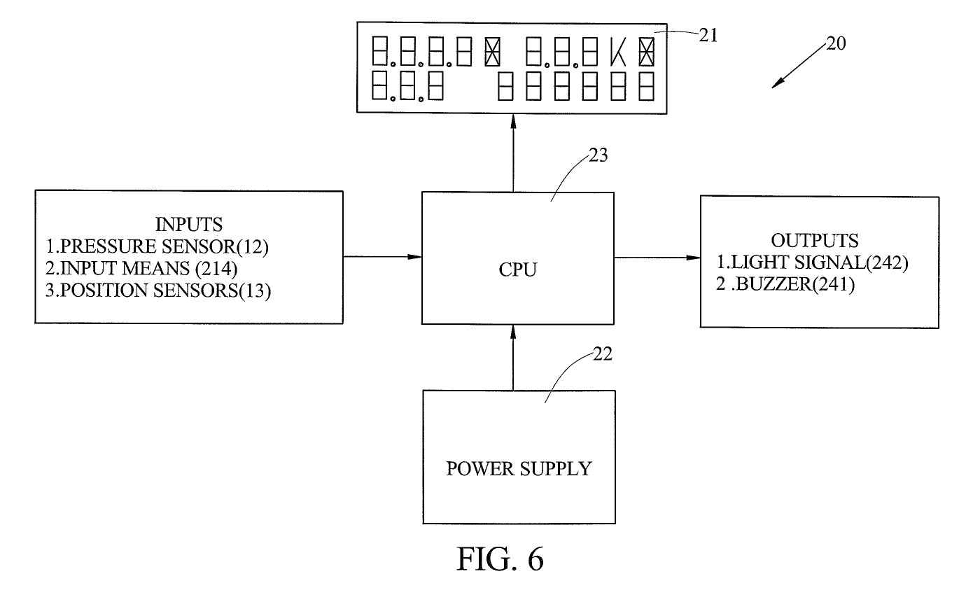

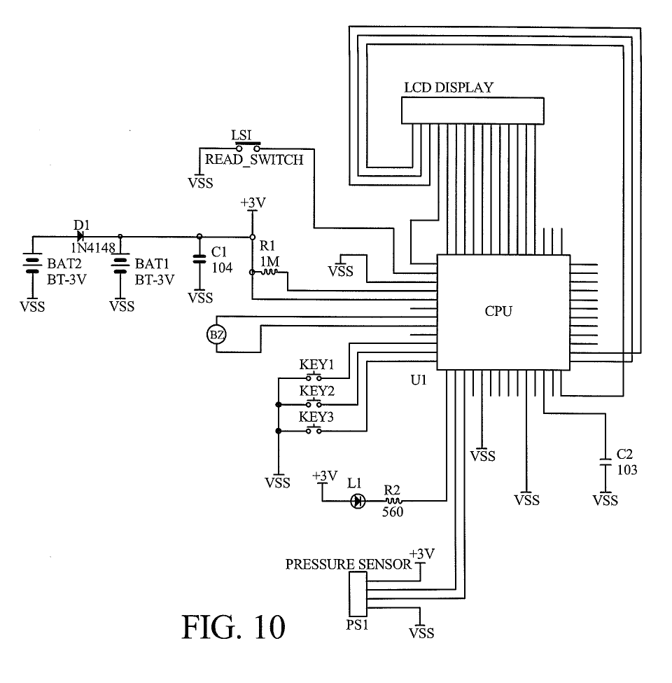

Referring to FIGS. 1 to 13E, a digital display apparatus 20 for an assembly of a pneudraulic fastener pulling tool 10 in accordance with the invention is shown. The assembly of a pneudraulic fastener pulling tool 10 is shaped as a pistol and can be driven by attaching to a hydraulic power source 30, a pneudraulic power source 30, or a pneumatic power source 30 depending on applications. The assembly of a pneudraulic fastener pulling tool 10 comprises a pneumatic piston rod 11 (see FIGS. 3A, 3C, 4A, and 4B) operable in a pneumatic cylinder 15, and a hydraulic piston rod 14 (see FIGS. 3A, 3C, 5A and 5B) operable in a hydraulic cylinder 16.

The digital display apparatus 20 is connected to the assembly of a pneudraulic fastener pulling tool 10 and comprises the following components as discussed in detail below. A power supply (e.g., charger and rechargeable battery, or single use cell) 22 can supply power to the digital display apparatus 20. A central processing unit (CPU) 23 is electrically connected to the power supply 22, a pressure sensor 12, a plurality of position sensors 13, an input means 214, a buzzer 241, a light signal (e.g., light-emitting diode (LED)) 242, and a display (e.g., liquid crystal display (LCD) display) 21.

The pressure sensor 12 can sense hydraulic or pneumatic pressure entering the tool 10. The display 21 comprises a pressure display zone 211 for showing hydraulic or pneumatic pressure value, a pulling force display zone 212 for showing pulling force which is obtained from the CPU 23, an over pressure display zone 213 for showing the maximum pressure entered the tool and sensed by the pressure sensor 12, and a cycle time display zone 215 for showing the accumulated cycle times of the tool 10. A warning device is issued when the accumulated cycle times reach the predetermined cycles for maintenance.

The CPU 23 comprises a pressure and pulling force calculation module, a unit conversion module, an over pressure detecting module, a cycle times counting module, and an abnormal stroke determination module.

The pressure and pulling force calculation module can convert pressure into pulling force by formulated parameter of each type of tool and show the sensed tool inlet pressure on the pressure display zone 211, and the corresponding instant pulling force on the pulling force display zone 212. Thus, an operator will know if the pulling force is powerful enough to set the fasteners in order to avoid failure setting and costly reworks.

The operator may use the unit conversion module to convert preferred units for the tool inlet pressure and the pulling force. The over pressure determination module can sense if the tool inlet pressure exceeds the predetermined safety limit and it always records (i.e., update) the highest reading and shows the same on the over pressure display zone 213 as warning. The recorded pressure cannot be initialized and is taken as a judgment whether the manufacturer is responsible for the warranty claim or not. Above is designed for aiming at safely operating of the tool 10.

The cycle time counting module can calculate the accumulated cycle times of the tool 10. The abnormal stroke detecting module can judge if the pulling stroke is insufficient by position sensors 13 to check if the pneumatic piston rod 11 will return to its normal position and issuing warning signals to call for attention or maintenance. The input means 214 is designed for entering and setting various operation parameters for each module and normally operable by manufacturer or his authorized personnel.

In FIG. 3A, the tool 10 is driven by pneudraulic power, herein, the reference number 14 is the hydraulic piston, reference number 11 is the pneumatic piston rod, the reference number 15 is the pneumatic cylinder, reference number 16 is the hydraulic cylinder, reference number 17 is the hydraulic connecting tube and reference number 18 is the pneumatic piston. Three position sensors 13 (i.e., two position sensors being around the outer end of the hydraulic connecting tube 17 and one sensor being on the top of the pneumatic piston rod 11) are provided for sensing the position of the piston rod 11 moving in the hydraulic connecting tube 17. The sensed position signal will be taken as the accumulated cycle times of the tool 10. The CPU 23 also comprises a cycle time counting module for accumulating the total cycles of the tool in use. It can be programmed as non-resettable and taken as the basis of warranty. It is shown on the cycle time display zone 215 in the display 21 and will remind operators to do maintenance as soon as the accumulated cycle times reach the predetermined cycles. This module can also be used for detecting if the piston rod 11 returns to its normal position after each motion cycle.

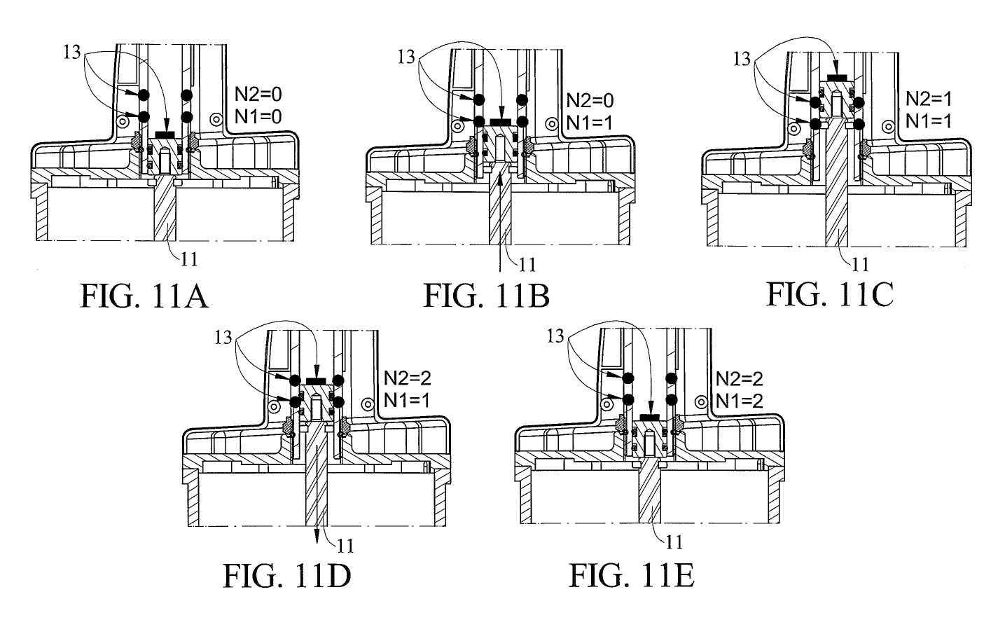

As shown in FIG. 11A to FIG. 11E, the position sensors 13 are provided for sensing the position of the piston rod 11 moving in the hydraulic connecting tube 17. By the logic of CPU 23, in FIG. 11A, N1=0 as sensed by the first position sensor 13 and N2=0 as sensed by the second position sensor 13 indicate that the tool is not activated yet. In FIG. 11B, N1=1 as sensed by the first position sensor 13 and N2=0 as sensed by the second position sensor 13 indicate that the tool is activated and the piston rod 11 has passed the first position sensor but has not reached the second position sensor 13. In FIG. 11C, N1=1 as sensed by the first position sensor 13 and N2=1 as sensed by the second position sensor 13 indicate that the piston rod 11 has passed both of the first and second position sensors 13, the tool is pulling the fastener (i.e., on the way up to top dead end of its stroke). In FIG. 11D, N1=1 as sensed by the first position sensor 13 and N2=2 as sensed by the second position sensor 13 indicate that the piston rod 11 has returned from the top dead end but has not returned to the original position (i.e., on the way back to bottom dead end). In FIG. 11E, N1=2 as sensed by the first position sensor 13 and N2=2 as sensed by the second position sensor 13 indicate that the piston rod 11 has returned to the bottom dead end. Thus a normal full cycle of the fastener pulling tool 10 completed and indicates that all oil seals are in good condition and no leakage occurs.

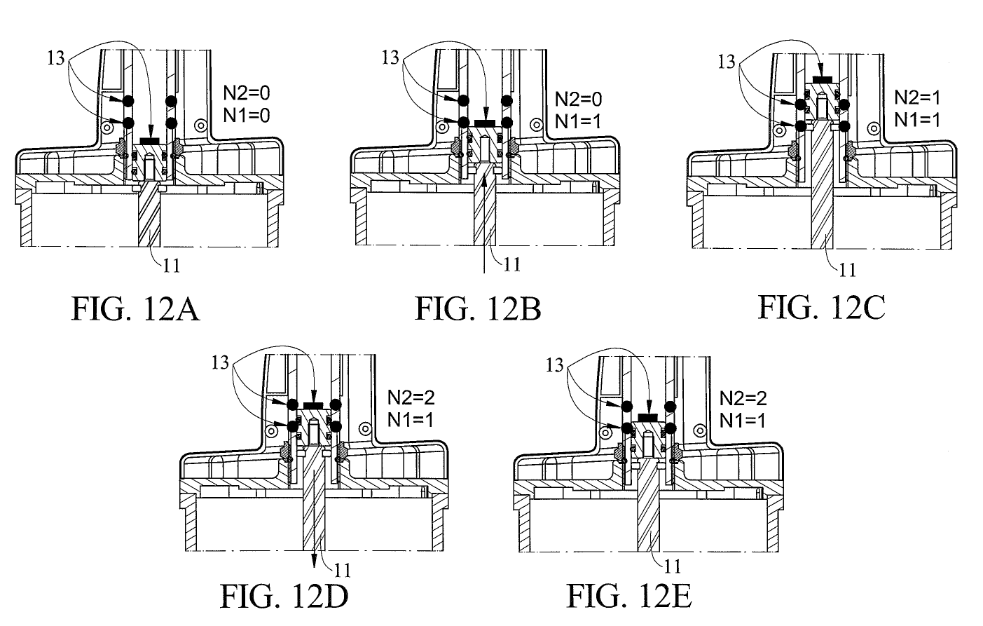

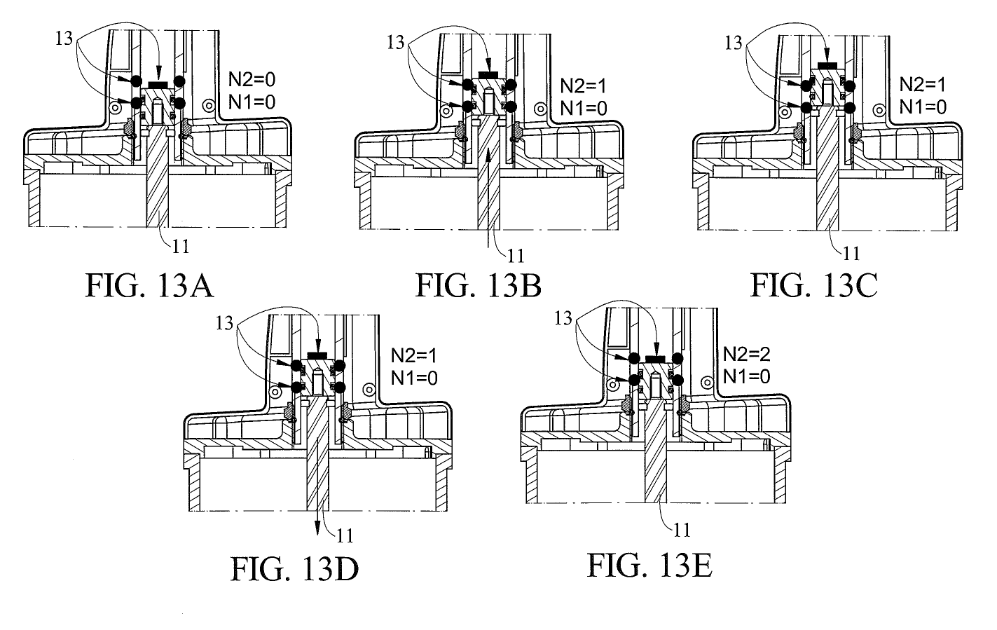

If N1≠2 or N2≠2 sensed by position sensor 13 show at the end of each motion cycle, it indicates that seals are damaged and cause leakage resulting in insufficient pulling stroke. For example, as shown in FIGS. 12A to 12E, the piston rod 11 stops in between the first and second position sensors 13 at the end of the motion cycle and read as N2=2 and N1=1 by CPU23. Further, as shown in FIGS. 13A to 13E, the piston rod 11 starts to move at a position between the first and second position sensor 13 at the beginning of the motion cycle with N2=2 and N1=0, and the piston rod 11 stops in between the first and second position sensors 13 at the end of the motion cycle with N2=2 and N1=0. It indicates that the tool 10 is under abnormal condition and starts to leak. Even the tool 10 is workable at the moment, but the warning signal will be actuated to call for maintenance. If the piston rod 11 is stopped beyond the second position sensor 13, it indicates that the tool 10 has serious leakage problem and the warning signal will be continuously issued for alerting the operator to do immediate remedy.

Warning devices can be a buzzer 241 which can generate a sound or voice as soon as over pressure is sensed, the accumulated cycle times have reached predetermined cycles for maintenance, or piston rod 11 does not return to its normal position. The warning devices further comprise a light signal (e.g., LED) 242 which can flash when above abnormalities occur.

The input means 214 comprises a plurality of keys. The digital display apparatus 20 can communicate with the tool 10 by wire or wireless.

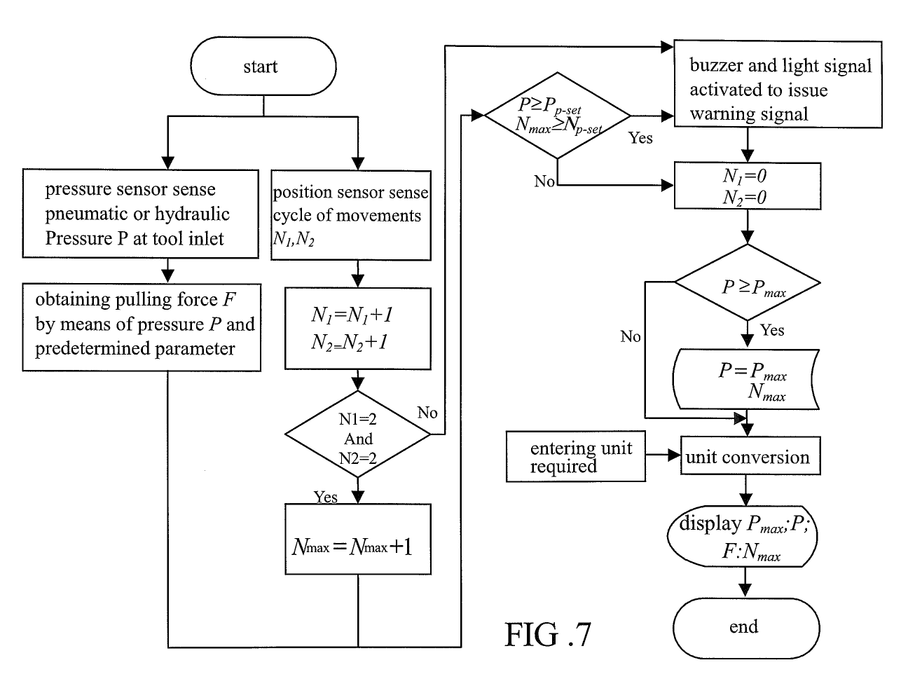

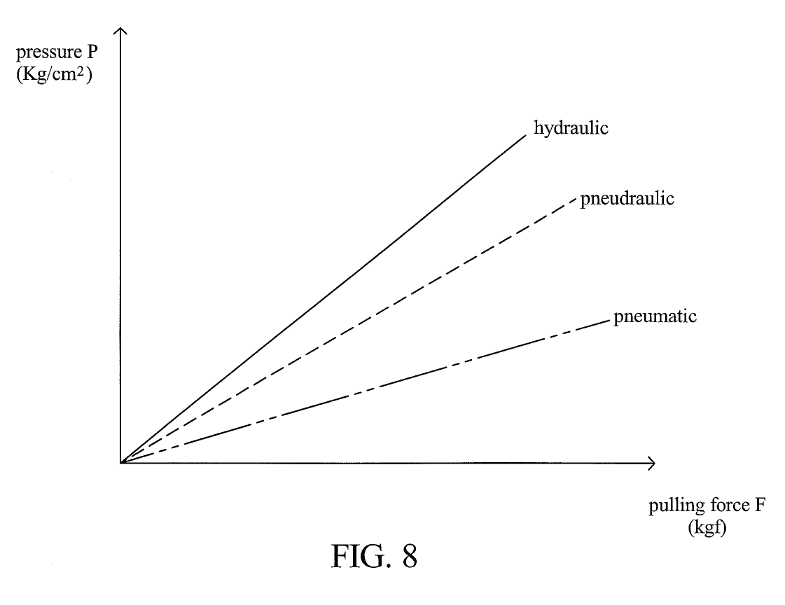

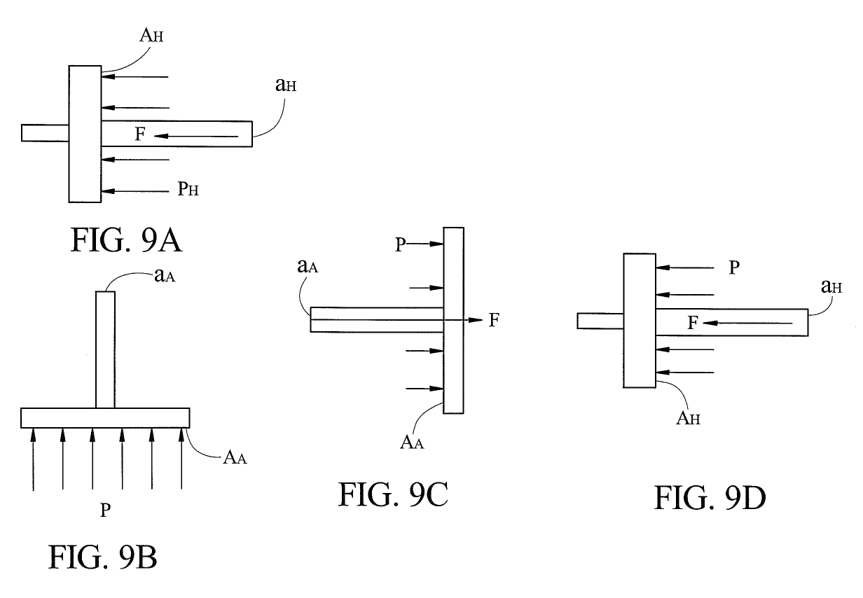

In FIG. 7, a flow chart of the invention is illustrated. P means inlet hydraulic or pneumatic pressure P, Pₘₐₓ means the maximum over pressure, F means pulling force, Pₚ₋ₛₑₜ means upper pressure limit of the tool 10, Nₘₐₓ means the accumulated cycle times, N1 means the cycle time detected by the first position sensor 13, N2 means the cycle time detected by the second position sensor 13, and Nₚ₋ₛₑₜ means the cycle time to call for maintenance. Thus, the over pressure determination module will determine if the operating pressure exceeds the maximum safety value, the CPU 23 will keep the record of the over pressure every time and issue warning signals simultaneously and shows only the highest over pressure Pₘₐₓ on the over pressure display zone 213. This will help to solve disputed warranty claim and clarify all relevant responsibilities. As shown in FIGS. 8 and 9A-9D, fastener pulling force of the tool 10 is closely related to hydraulic or pneumatic pressure and piston and piston rod diameters it applied. For example, in FIG. 9A and FIG. 9B, a pneumatic-hydraulic driving mechanism of a fastener pulling tool, A_{A} means pneumatic piston sectional area and a_{A} means pneumatic piston rod sectional area, and A_{H} means hydraulic piston sectional area and a_{H} means hydraulic piston rod sectional area. For the tool 10 driven hydraulically and pneumatically, pressure P is exerted on the pneumatic piston and the piston rod is pushed upward to increase pressure of hydraulic fluid in the hydraulic cylinder (see FIG. 9B). And in turn, hydraulic piston is pushed by hydraulic fluid to exert a pulling force P on the fastener. Pulling force F and pressure P can be expressed in the following expression:

$$F = \frac{P \times {A}_{A}}{{a}_{A}} ( {A}_{H} - {a}_{H} ) \qquad ( equation 1 )$$

where P×A_{A}/a_{A} is hydraulic pressure P_{H} built in the hydraulic cylinder, the CPU 23 can, based on value sensed by the over pressure determination module, determine whether inlet pneumatic pressure P and inlet hydraulic pressure P_{H} are within the safety limits or not.

In equation 1, A_{A}, a_{A}, A_{H}, and a_{H} are known parameters when the tool is designed. Hence, equation 1 can be rewritten as F=C_{A-H}×P, where C_{A-H}=(A_{A}/aₐ)×(A_{H}−a_{H}) is a constant which can be regarded as a parameter to be substituted in F=C_{A-H}×P. Thus, pressure in the tool 10 sensed by the pressure sensor can be converted into pulling force F.

For pneumatic fastener pulling tool,

F=P(A_{A}−a_{A})=C_{A}×P (equation 2)

For hydraulic fastener pulling tool,

F=P(A_{H}−a_{H})=C_{H}×P (equation 3)

From equations 1, 2, and 3, it is found that pressure P is proportional to pulling force F. That is, the higher of pressure the greater of pulling force.

In short, the pressure sensor 12 senses pressure of hydraulic or pneumatic fluid entering the tool 10. The CPU 23 will calculate a corresponding pulling force F. The display 21 shows pressure and corresponding pulling force F. The CPU 23 further determines if the tool inlet pressure exceeds the designed pressure limit. If there is any abnormality, the light signal 242 and the buzzer 241 will be activated to issue warning signals. The position sensors 13 can sense piston position. The CPU 23 also can calculate the accumulated cycle times of the tool 10 and determine whether the piston has returned to its normal position at the end of each motion cycle. Both the light signal 242 and the buzzer 241 will be activated to issue warning signals if the accumulated cycle times have reached the predetermined cycles for maintenance or the piston does not return to its normal position at the end of each motion cycle.

While the invention has been described in terms of preferred embodiments, those skilled in the art will recognize that the invention can be practiced with modifications within the spirit and scope of the appended claims.

What is claimed is:

1. A digital display apparatus for a fastener pulling tool to set a fastener (e.g., rivet, blind rivet or blind threaded insert), driven by pneumatic, hydraulic or pneudraulic power, comprising:
a power supply;
a central processing unit (CPU);
a pressure sensor;
a plurality of position sensors;
a display; and
input means;
wherein the power supply is operable to supply power to the digital display apparatus;
the pressure sensor is electrically connected to the CPU for communicating data therewith;
the input means is electrically connected to the CPU;
the display is electrically connected to the CPU for showing information therefrom;
the pressure sensor is operable to sense pressure of hydraulic or pneumatic fluid entering the fastener pulling tool;
the CPU comprises a pressure and pulling force calculation module, a unit conversion module, an over pressure determination module, a cycle times counting module, and an abnormal stroke detecting module;
the display comprises a pressure display zone for showing hydraulic or pneumatic pressure and a pulling force display zone for showing corresponding pulling force instantly; and a non resettable over pressure display zone showing the highest tool inlet pressure and a non-resettable cycle time display zone showing accumulated cycle times; and
the input means is operable for entering parameters to convert hydraulic or pneumatic pressure to corresponding pulling force, entering predetermined highest working pressure limit for judging over pressure, entering predetermined cycle times for reminding maintenance, and selecting preferred units of pressure and pulling force.

2. The digital display apparatus of claim 1, wherein the CPU further comprises a pressure and pulling force calculation module, showing the pulling force instantly corresponding to the tool inlet pressure by entering designed parameters for various size or specification of the fastener pulling tools individually during assembly of the tool, wherein the parameters are figured tool by tool according to the working surface area where the pressure to be applied.

3. The digital display apparatus of claim 1, wherein the CPU further comprises a unit conversion module for selecting preferred units of pressure or pulling force.

4. The digital display apparatus of claim 1, wherein the CPU further comprises an over pressure determination module for determining whether the inlet pressure of hydraulic or pneumatic fluid sensed by the pressure sensor is greater than a predetermined safety value or not and recording same as a maximum pressure value, the display further comprises an over pressure display zone for showing the maximum pressure value, and wherein the digital display apparatus further comprises a warning means for issuing warning signal when the maximum pressure value is greater than the predetermined safety value.

5. The digital display apparatus of claim 1, wherein the CPU further comprises a cycle times counting module for recording cycle times of the fastener pulling tool while pulling a fastener based on movements of a piston rod reciprocally moving in the fastener pulling tool as sensed by the position sensors, and wherein the display further comprises an accumulated cycle times display zone for showing accumulated cycle times of the fastener pulling tool such that the warning means is operable to issue warning signal when the accumulated cycle times reach predetermined cycles for maintenance.

6. The digital display apparatus of claim 1, wherein the CPU further comprises an abnormal stroke detecting module for determining whether the piston is disposed in a predetermined position at end or start of a stroke as sensed by the position sensors such that the warning means is operable to issue warning signal when the piston is not disposed in the predetermined position at the end or start of the stroke and is taken as warning of insufficient stroke or oil seal leakage prior to periodical maintenance.

7. The digital display apparatus of claim 1, wherein the CPU further comprises a unit conversion module for unit conversion of pressure and pulling force by manipulating the input means.

8. The digital display apparatus of claim 1, wherein the power supply is either a unit comprising a charger and a rechargeable battery, or a single use cell.

9. The digital display apparatus of claim 1, wherein the warning means comprises a buzzer.

10. The digital display apparatus of claim 1, wherein the warning means comprises a light signal.

11. The digital display apparatus of claim 1, wherein the input means comprises a plurality of keys.
